(19) United States
(12) Patent Application Publication
(10) Pub. No.: US 2024/0210897 A1
(43) Pub. Date: Jun. 27, 2024

(54) DISPLAY DEVICE AND WATCH

(71) Applicant: CASIO COMPUTER CO., LTD., Tokyo (JP)

(72) Inventor: Jun MIWA, Tokyo (JP)

(73) Assignee: CASIO COMPUTER CO., LTD., Tokyo (JP)

(21) Appl. No.: 18/538,592

(22) Filed: Dec. 13, 2023

(30) Foreign Application Priority Data
Dec. 22, 2022 (JP) 2022-205512

(51) Int. Cl. G04G 17/04; F21V 8/00

(52) U.S. Cl. CPC G04G 17/045; G02B 6/0086

(57) ABSTRACT

A display device includes: a light emitting body; a component unit having a plurality of electronic components;

and a light guide plate including a plate portion arranged to face the component unit; and a convex portion protruding from the plate portion toward the component unit and having a side face portion facing the light emitting body and a slope portion facing the component unit, in which the plurality of electronic components are arranged to be spaced apart from the light guide plate in a facing direction, and at least one of the electronic components is arranged at a position overlapping the slope portion as viewed from a normal direction of the plate portion.

### CROSS-REFERENCE TO RELATED APPLICATIONS

This application is based upon and claims the benefit of priority from Japanese Patent Application No. 2022-205512, filed Dec. 22, 2022, the entire contents of which are incorporated herein by reference.

### FIELD

The present invention relates generally to a display device and a watch.

### BACKGROUND

Conventionally, as a display device for use in a wristwatch, etc., there exists a display device in which an

LCD, a light guide plate, and a reflection plate are stacked in order, and are arranged to face a circuit board on which various electronic components are mounted.

### SUMMARY

A display device according to an embodiment includes: a light emitting body; a component unit having a plurality of electronic components; and a light guide plate including a plate portion arranged to face the component unit; and a convex portion protruding from the plate portion toward the component unit and having a side face portion facing the light emitting body and a slope portion facing the component unit, in which the plurality of electronic components are arranged to be spaced apart from the light guide plate in a facing direction, and at least one of the electronic components is arranged at a position overlapping the slope portion as viewed from a normal direction of the plate portion.

### BRIEF DESCRIPTION OF THE DRAWINGS

FIG. 1 is a plan view of a watch according to a first embodiment.

FIG. 2 is a sectional view of the watch.

FIG. 3 is a partially enlarged sectional view of the watch.

FIG. 4 is a plan view of a circuit board of the watch.

### DETAILED DESCRIPTION

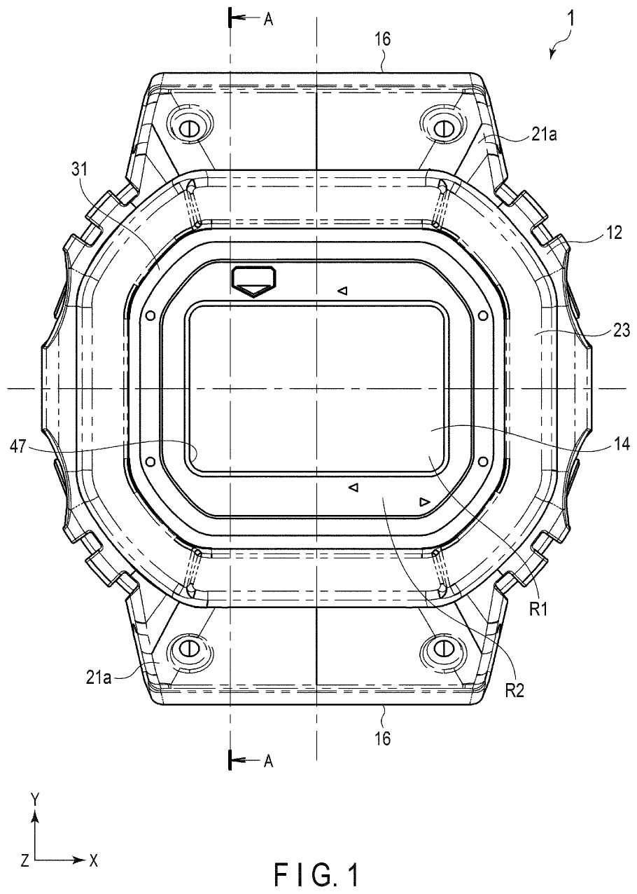

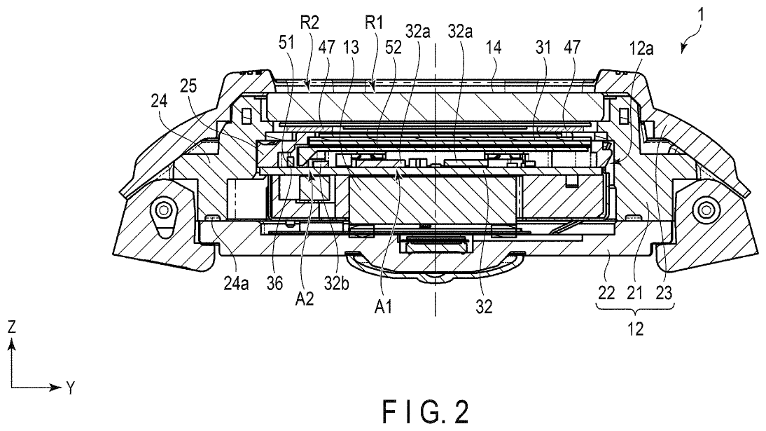

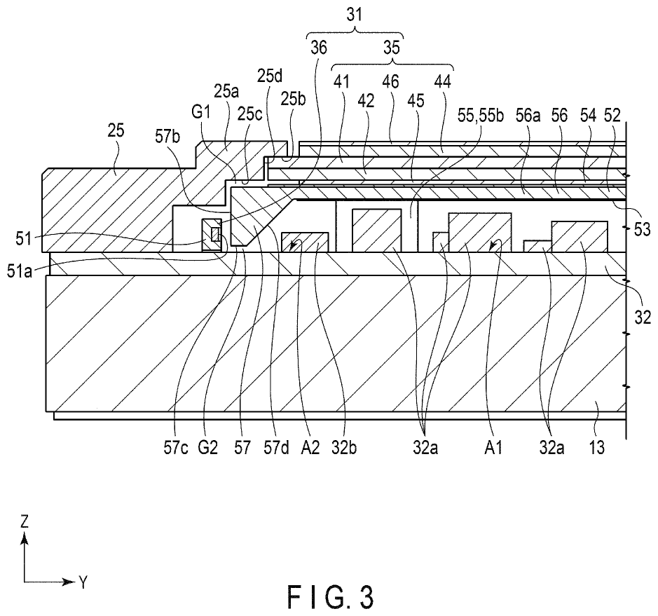

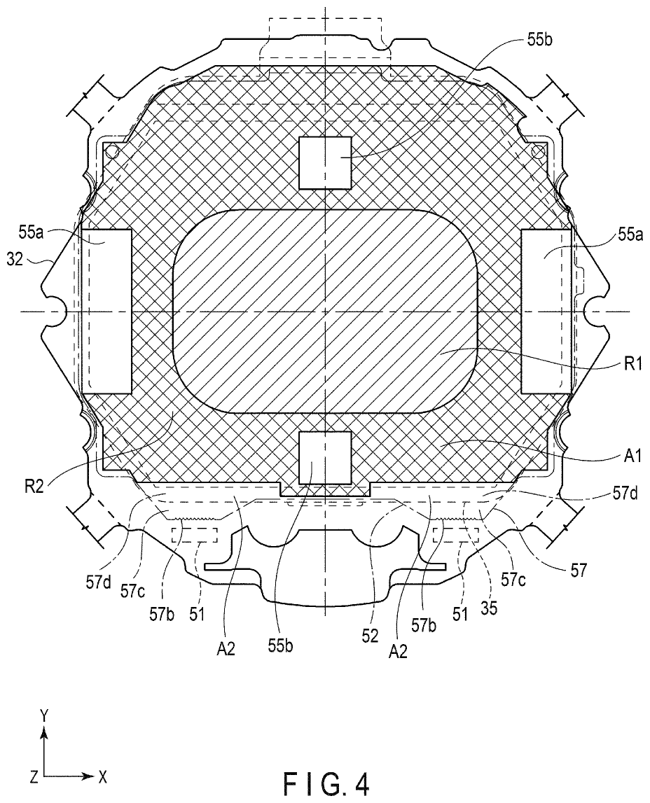

Hereinafter, a display device 31 and a watch 1 according to a first embodiment of the present invention will be described with reference to FIG. 1 to FIG. 4. FIG. 1 is a sectional view showing some portions of a watch 1 according to the first embodiment. FIG. 2 is a sectional view taken along line A-A of FIG. 1, and FIG. 3 is a partially enlarged sectional view. FIG. 4 is a plan view of a circuit board. The present embodiment describes an example case in which the display device 31 is applied to a dial plate of the watch 1. In the drawings, X, Y, and Z respectively indicate three directions that are perpendicular to each other. The description will assume that the X axis is a horizontal direction connecting 3 o'clock and 9 o'clock of the watch 1, the Y axis is a vertical direction connecting 12 o′clock and 6 o'clock of the watch 1, and the Z axis is a front and back direction (first direction) of the watch 1. For the sake of explanation, FIG. 4 illustrates a visible region R1 serving as a first region using diagonal hatching in one direction, and a cover region R2 serving as a second region using diagonal hatching in two directions that intersect with each other.

The watch 1 shown in FIG. 1 and FIG. 2 is, for example, a wristwatch, and includes a watch case 12 forming an outer shell, a watch module 13 provided inside the watch case 12, and a cover 14 covering a front side of the watch module 13. The watch 1 also includes a watch band 16 connected to two locations on the outer periphery portion of the watch case 12 and a plurality of switches arranged on the outer periphery of the watch case 12.

Conventionally, there exists a display device provided with a slope surface in which a light guide plate gradually decreases in thickness at a location from one end side to the other end side of an LCD.

However, such a display device has a problem that it is difficult to secure a mounting area between a circuit board and a light guide plate.

Hereinafter, a display device and a watch which are to improve such a situation and are capable of securing a mounting area will be described.

The watch case 12 includes a housing 21 disposed around the outer periphery portion of the watch module 13, a back cover 22 arranged on the back side of the watch module 13, and an exterior case 23. The watch case 12 forms, by means of the housing 21 and the back cover 22, a container portion 12a in which the watch module 13 is arranged. An opening on the front side of the housing 21 is covered with the cover 14. In the present embodiment, the watch case 12 is formed into an octagonal shape.

The housing 21 includes band attachment portions 21a at two locations facing each other on the outer periphery portion, for example at the 6 o′clock and 12 o′clock positions, respectively, and the watch band 16 is attached to each of the band attachment portions 21a.

The housing 21 is made of metal or resin material. The housing 21 is formed into, e.g., an octagonal frame shape corresponding to the shape of the watch case 12. In the housing 21, the container portion 12a that contains therein the watch module 13, etc., is formed. The housing 21 May be configured by combining a plurality of case members. For example, the housing 21 in the present embodiment is configured by assembling a main case member 24 and an inner case member 25 provided on the inner peripheral edge of the main case member 24.

The main case member 24 is formed into, e.g., an octagonal annular shape corresponding to the shape of the watch case 12. The main case member 24 covers the outer periphery portion of the watch module 13 and the inner case member 25. A groove 24a is formed in the edge of the back surface side of the main case member 24. A waterproof ring that makes a gap between the groove 24a and the back cover 22 airtight is attached to the groove 24a.

For example, the inner case member 25 is provided at the inner peripheral edge of the main case member 24 and supports a circuit board 32 and a display device 31 that correspond to some portions of the watch module 13. The inner case member 25 is formed into a shape corresponding to the shape of the watch case 12, for example, an octagonal frame shape.

As shown in FIG. 3, for example, the inner case member 25 has a support wall portion 25a that supports the display device. The support wall portion 25a has a plurality of steps corresponding to the arrangement of the components. For example, the support wall portion 25a is provided on at least a portion of the inner peripheral edge of the inner case member 25, and has a first surface 25b facing a front side of a peripheral edge of an LCD 35, a second surface 25c facing a front side of a peripheral edge of a light guide plate, and a connecting surface 25d that continuously connects the first surface 25b and the second surface 25c.

The first surface 25b is a plane that is perpendicular to the first direction, which is the thickness direction of the display device 31 and the watch 1, and faces the back surface side. The first surface 25b is arranged to face the front surface side of the peripheral edge of the LCD 35, is in contact with the peripheral edge of the LCD 35, and presses the LCD 35 toward the back surface side. In the present embodiment, the first surface 25b is arranged to face the outer peripheral edge of the electrode board 41 at the front side, which constitutes the LCD 35.

The second surface 25c is a plane that is perpendicular to the first direction, which is the thickness direction of the display device 31 and the watch 1, and faces the back surface side. The second surface 25c is arranged to face a front side of a peripheral edge of a light guide plate 52. The second surface 25c faces the surface of the peripheral edge of the light guide plate 52 with a gap G1 therebetween. The second surface 25c is located closer to the back side which is the other side of the first direction than the first surface 25b. Herein, the distance in the first direction between the second surface 25c and the first surface 25b, that is, the height in the first direction of the connecting surface 25d, which is a step, is approximately equal to the thickness dimensions of the electrode boards 41 and 42 of the LCD 35.

The connecting surface 25d is an inner wall surface that stands upright in the first direction and connects the first surface 25b and the second surface 25c, and is disposed to face the outer peripheral surfaces of the electrode boards 41 and 42.

The exterior case 23 is formed into, for example, an octagonal frame shape corresponding to the shape of the watch case 12, and is provided on the front side of the outer periphery of the housing 21. The exterior case 23 is fixed to the housing 21 by means of a connection member such as a screw.

As shown in FIGS. 2 and 3, the watch module 13 includes the display device 31 that displays various types of information such as time, the circuit board 32 (component unit) on which various electronic components 32a and 32b such as an IC and an antenna serving as a drive portion configured to operate the display device 31 are mounted, and spacers 55a and 55b arranged between the circuit board 32 and the display device 31. The watch module 13 further includes a battery, a solar board, various sensor components, and various other components necessary for the watch function. In the present embodiment, each of the display device 31 and the circuit board 32 arranged in a stacked manner is formed into an octagonal shape corresponding to the shape of the watch case 12, for example.

For example, the display device 31 includes the LCD 35 (liquid crystal display panel) of a transmissive type and a lighting device 36. For example, the display device 31 is a digital display unit and includes a digital display function.

The LCD 35 includes a pair of transparent electrode boards 41 and 42 that are stacked with the liquid crystal material layer interposed therebetween, and a pair of polarizing plates 44 and 45 that are stacked on the front surface of the pair of electrode boards 41 and the back surface of the electrode board 42, respectively, and an optical sheet 46. The LCD 35 is arranged on the opposite side of the circuit board 32 of the light guide plate 52 in such a manner as to face the light guide plate 52.

The transparent electrode boards 41 and 42 forming a pair have transparent electrodes arranged in a matrix on their facing surfaces. An overlapping portion of the transparent electrodes of the electrode boards 41 and 42 forming a pair constitutes a pixel, so that pixels arranged in a matrix are formed. For example, the LCD 35 is electrically connected to the circuit board 32 and is given a drive signal from the circuit board 32 to display information electro-optically. That is, the LCD 35 displays information such as characters and patterns by pixels arranged in a matrix being selectively shielded from light by selective application of a voltage to the transparent electrodes of the electrode boards 41 and 42. Furthermore, the outer periphery portion of the LCD 35 is provided with a decorative panel 47. The LCD 35 has the center portion provided with the visible region R1 configured to allow display information to be visible from the front side, and the outer periphery provided with the cover region R2. The visible region R1 is formed into, for example, a rectangular shape.

The polarizing plate 45 on the back side, which is the back surface of the LCD 35, is placed in close contact with a front side of a diffusion plate 54 of the lighting device 36 in such a manner as to face the diffusion plate 54.

The electrode board 41 on the front side of the LCD 35 is arranged to face the back side of the first surface 25b of the inner case member 25 at the periphery, and the polarizing plate 44 on the front side is arranged on the inner circumferential side as compared to the support wall portion 25a of the inner case member 25.

The lighting device 36 is provided on the back side of the LCD 35 and emits light from the back side of the LCD 35. The lighting device 36 includes a light emitting body 51, the light guide plate 52, a reflection plate 53, and the diffusion plate 54.

The light emitting body 51 is provided on the outer peripheral side of the light guide plate 52 on the circuit board 32. Specifically, the light emitting body 51 is arranged to face one side of the light guide plate 52. As in the example shown in FIG. 4, the light emitting bodies 51 are respectively arranged at two locations in the region on the 6 o'clock side, for example, the vicinities of the 5 o'clock and 7 o'clock positions. Each of the light emitting bodies 51 is, for example, a light emitting diode (LED) element, and emits light in the visible light range, such as white light. The light emitting body 51 is electrically connected to the circuit board 32.

The light emitting body 51 has a light source 51a that emits light toward the end surface of the light guide plate 52. The light source 51a is arranged at the center of the facing surface of the light emitting body 51, which faces the light guide plate 52. For example, in the present embodiment, the light source 51a emits light from the end on the 6 o'clock side toward the 12 o'clock side.

The light guide plate 52 is made of a transparent or semi-transparent light transmitting material and is formed into a plate shape. For example, the light guide plate 52 integrally includes a plate portion 56 formed into a flat plate shape and a convex portion 57 protruding toward the back side at an end of the plate portion 56. For example, the light guide plate 52 is smaller than the outer shape of the circuit board 32 and faces the mounting area at the center of the circuit board 32. Furthermore, the light guide plate 52 is larger than the outer shape of the LCD 35. The light guide plate 52 is formed into, for example, an octagonal outer shape. The light guide plate 52 is provided with a predetermined light guide pattern that guides light from the light emitting body 51 in such a manner as to uniformly emit the light from the surface on the front side. The light guide pattern is formed to be denser from one side to the other side in such a manner that its part close to the light emitting body 51 is coarse and its part far from the light emitting body 51 is dense, and is configured in such a manner as to emit an incident light from the upper surface (surface). For example, the light guide pattern may be formed only on a thin portion 56a of the light guide plate 52, excluding the convex portion 57, or may be formed in a region of the plate portion 56, including the convex portion 57.

The convex portion 57 is provided at the end of the plate portion 56 on the light emitting body 51 side.

The convex portion 57 is a thick protrusion constituted by the end portion of the plate portion 56 protruding toward the back side. The convex portion 57 is configured in such a manner that its thickness dimension in the first direction is set to a predetermined thickness greater than the thickness dimension of the thin portion 56a at the center of the plate portion 56.

In the present embodiment, as in one example shown in FIG. 4, the convex portions 57 are respectively provided at the 5 o′clock and 7 o′clock positions of the watch 1. In each of the convex portions 57, a region extending in the horizontal direction protrudes toward the back surface side. For example, the convex portion 57 is arranged in the cover region R2 that is located outside the central visible region R1 allowing display information to be visible as viewed from the front side of the watch, is covered with the decorative panel 47 shown in FIG. 2, and is not visible from the front side.

As shown in FIG. 3, the convex portion 57 of the light guide plate 52 includes a side surface portion 57bfacing the light emitting body 51, a back end surface portion 57c facing the circuit board, and a slope portion 57d, and is configured in such a manner that the cross-section as seen in the horizontal direction connecting the 3 o'clock point and the 9 o'clock point forms a substantially trapezoidal shape.

The side surface portion 57b of the convex portion 57 of the light guide plate 52 faces the light emitting body 51. The side surface portion 57b forms an incident surface where light enters. The side surface portion 57b is provided at a position facing the light source 51a in the vertical direction, which is the incident direction extending from the 6 o'clock side to the 12 o'clock side.

The back end surface portion 57c of the convex portion 57 of the light guide plate 52 is formed into, for example, a flat plate shape. The back end surface portion 57c is provided at a position closer to the back side than the light source 51a, and is arranged on the circuit board 32 with a predetermined gap G2 therebetween in such a manner as to face the circuit board 32. The back end surface portion 57c is arranged at a position closer to the circuit board 32 (the back side of the watch 1) than the light source 51a of the light emitting body 51 in the first direction.

The slope portion 57d of the convex portion 57 of the light guide plate 52 is an inclined surface that is inclined from the inner end of the back end surface portion 57c toward the center. The slope portion 57d is constituted by the surface of the back side of the plate portion 56 extending obliquely toward the circuit board 32, and forms a surface inclined with respect to the first direction and a surface direction perpendicular to the first direction. The slope portion 57d is arranged to face the circuit board 32 in the first direction.

The reflection plate 53 is provided on the back side of the light guide plate 52 and is formed into a flat plate shape. The reflection plate 53 reflects the light leaking from the plate portion 56 toward the light guide plate 52 and guides it to the light guide plate 52 again.

The diffusion plate 54 is a light-transmitting plate that is arranged between the light guide plate 52 and the LCD 35 and has light transmissivity. The diffusion plate 54 is arranged in such a manner that its front surface is in close contact with the back surface of the LCD 35 and its back surface is in close contact with the surface of the light guide plate 52. The diffusion plate 54 diffuses light from the light guide plate 52 and uniformly emits the light from the upper surface. By the diffusion plate 54 being interposed between the light guide plate 52 and the LCD 35 in the first direction, which is the facing direction, the gap G1 corresponding to the thickness of the diffusion plate 54 and the polarizing plate 45 is created between the second surface 25c and the surface of the peripheral edge of the light guide plate 52.

The circuit board 32 is a board provided with a predetermined wiring pattern and having the plurality of electronic components 32a and 32b mounted on its surface. The circuit board 32 is arranged to face the back surface side of the light guide plate 52. In FIG. 4, the LCD 35 placed over the circuit board 32 is indicated by a broken line, and the light guide plate 52 is indicated by a chain line. Herein, at least a portion of any one or more electronic components 32b among the electronic components 32a and 32b is arranged at a position facing the slope portion 57d in the first direction, and the end surface facing the light guide plate 52 of the electronic component 32b arranged on the slope portion 57d is arranged at a position further away from the light guide plate 52 in the facing direction than the end surface facing the light guide plate 52 of the electronic component 32a disposed to face the thin portion 56a of the plate portion 56. That is, in the case where the display device 31 of the watch 1 is viewed in plan view from the viewing side, assume that a region of the circuit board 32, which overlaps one side in the first direction of the thin portion 56a of the plate portion 56 of the light guide plate 52, is defined as a first mounting region A1, and a region which overlaps one side in the first direction of the slope portion 57d of the convex portion 57 at the end of the light guide plate 52 is defined as the second mounting region A2. In this case, the maximum height of one or more electronic components 32b arranged in the second mounting region A2 is smaller than the maximum height of one or more electronic components 32a arranged in the first mounting region A1.

That is, the surface of the electronic component 32b on the back side of the slope portion 57d of the convex portion 57 is located closer to the back side than the surface of the electronic component 32b on the back side of the thin portion 56a of the plate portion 56.

The plurality of spacers 55a and 55b are provided between the circuit board 32 and the reflection plate 53 of the lighting device 36, and regulate the distance between the light guide plate 52 and the circuit board 32 in the first direction. The plurality of spacers 55a and 55b are made of a cushioning member such as urethane formed into, for example, a rectangular block shape. As shown in FIG. 4, for example, the plurality of spacers 55 are provided outside the visible region R1 on the circuit board 32.

As shown in FIG. 3, for example, the dimensions of the spacers 55a and 55b in the first direction are set to a height that allows compression of the light guide plate 52 to be suppressed by forming the gap G2 between the back end surface portion 57c of the convex portion 57 of the light guide plate 52 and the surface of the circuit board 32.

The spacers 55a and 55b are attached to predetermined locations on the outer periphery site of the circuit board 32. For example, as shown in FIG. 4, in the present embodiment, the spacers 55a and 55b are provided at a total of four locations on both sides in two directions, the vertical direction and the horizontal direction, that is, at the 12 o'clock, 3 o'clock, 6 o'clock, and 9 o'clock positions. As an example, the present embodiment includes two types spacers including the first spacers 55a and the second spacers 55b that are different in size. For example, the large first spacers 55a are respectively arranged at 3 o'clock and 9 o'clock positions on both sides in the horizontal direction, and the small second spacers 55b extending in the vertical direction are respectively provided at 6 o'clock and 12 o'clock positions on both sides in the vertical direction. For example, in the present embodiment, a terminal for connecting a connector is arranged at the 12 o'clock position on one side in the vertical direction, and each of the spacers 55 is arranged at a position closer to the center than this terminal.

The cover 14 is a transparent member made of, for example, inorganic glass such as SiO2 glass. For example, the cover 14 is a transparent watch glass formed into an octagonal shape, and is placed on the front side of the watch module 13 to cover the watch module 13. For example, the cover 14 is supported on the inner peripheral edge of the opening on the front side of the housing 21. A packing is interposed between the outer periphery of the cover 14 and the inner periphery edge of the housing 21.

The watch band 16 includes a coupling mechanism such as a pair of band members or buckles, which are respectively connected to two facing locations on the outer periphery of the watch case 12.

The switch is provided on, for example, the outer periphery portion of the case, and performs mode changing, time adjustment, etc., of the watch module 13 in response to an operator's pressing operation.

In a process of assembling the display device 31, for example, the LCD 35 is set from the back side of the container portion 12a of the housing 21. At this time, the outer periphery portion of the electrode board 41 on the front side of the LCD 35 is arranged to face the first surface 25b of the housing 21 and is supported thereby. The first polarizing plate 45 and an optical sheet 46 are located closer to the inner peripheral side than the support wall portion 25a and are arranged on the front side of the first surface 25b. The diffusion plate 54, the light guide plate 52, and the reflection plate 53 are then bonded in order to the back side of the LCD 35 and are brought into close contact with each other. In this manner, the lighting device is constructed. Thereafter, the circuit board 32 on which the electronic components 32a and 32b are mounted and to which the spacer 55 is attached in advance is assembled into the lighting device. At this time, the light guide plate 52 and the LCD 35 are pushed up to the front side by the spacer 55a.

With the display device 31 according to the present embodiment, at least one of the plurality of electronic components 32a and 32b is arranged at a position overlapping the slope portion 57d in plan view from the normal direction of the plate portion 56. That is, the electronic component 32a can also be placed at a position facing the back side of the slope portion 57d provided at the end of the light guide plate 52. Furthermore, the electronic component 32a corresponding to the slope portion 57d is set to be smaller in height than the electronic component 32b facing the thin wall portion 56a of the plate portion 56 and is separated from the light guide plate 52. In this manner, a mounting area can be secured more effectively while improving impact resistance, so that higher functionality and miniaturization can be achieved.

Furthermore, in the display device 31 according to the present embodiment, the light guide plate 52 has the slope portion 57d from the convex portion 57 on the light emitting body 51 side, and most of an area of the light guide plate 52 is occupied by the thin wall portion 56a, so that only the electronic components 32b with a small height can be arranged on the slope portion 57d. However, even with many electronic components 32a having a great height, many electrode components with a great height can be arranged on the thin wall portion 56a having a large area with respect to the slope portion 57d.

The embodiment is discussed merely as an example, which should not be considered to restrict the scope of invention. Furthermore, the features in a plurality of embodiments may be combined.

### (Modification Examples)

In the example case described in the above embodiment, the surface of the circuit board 32 (component unit) is flat and the electronic components 32a and 32b are different in height; however, the present invention is not limited to this. The circuit board 32 May be configured in such a manner that its height varies depending on the site. For example, the circuit board 32 May be configured in such a manner that its height in the first direction is different between the second mounting region A2 of the slope portion 57d and the first mounting region A1 of the plate portion 56 (thin portion 56a). Even if the height of the electronic component 32a and the height of the electronic component 32b are approximately the same, it suffices that the circuit board 32 is arranged in such a manner as to have its portion on which the electronic component 32a in the first mounting region A1 is mounted be closer to the LCD35 in the first direction than its portion on which the electronic component 32b in the second mounting region A2 is mounted. Even in this case, by making an arrangement in which the end surface (top surface) of the electronic component 32b in the second mounting region A2 is further away from the plate portion 56 (thin portion 56a) of the light guide plate 52 than the end surface (top surface) of the electronic component 32a in the first mounting region A1, the mounting area can be used effectively and higher functionality can be achieved.

Furthermore, the example described above includes the light emitting body 51 at one end; however, the present invention is not limited to this. For example, the present embodiment may be configured in such a manner that the light emitting body 51 is arranged in the center or both end portions of the LCD 35 or the light guide plate 52.

Furthermore, the shapes and positions of the spacers 55a and 55b are not limited to those in the above embodiment. For example, in the case where the reflection plate 53 has deflection in a predetermined roll direction, the deflection of the reflection plate 53 can be suppressed by providing the spacers 55a and 55b on at least both sides in the roll direction.

Although several embodiments of the present invention have been described, the specific configuration, structure, positional relationship, etc. shown in the above embodiments can be changed as appropriate without departing from the spirit of the present invention. The scope of the present invention is included within the scope of the invention described in the claims and their equivalents.

What is claimed is:

1. A display device comprising:
a light emitting body;
a component unit having a plurality of electronic components; and
a light guide plate including a plate portion arranged to face the component unit and
a convex portion protruding from the plate portion toward the component unit and having a side face portion facing the light emitting body and a slope portion facing the component unit, wherein
the plurality of electronic components are arranged to be spaced apart from the light guide plate in a facing direction, and
at least one of the plurality of electronic components is arranged at a position overlapping the slope portion in plan view from a normal direction of the plate portion.

2. The display device according to claim 1, wherein a side surface facing the light guide plate of the electronic component arranged at a position corresponding to the slope portion is arranged at a position further away from the plate portion in a facing direction than an end surface facing the light guide plate of the electronic component arranged at a position corresponding to the plate portion.

3. The display device according to claim 1, further comprising an LCD arranged to face a front side of the light guide plate; and
a circuit substrate on which the plurality of electronic components are mounted and which is arranged to face a back side of the light guide plate.

4. The display device according to claim 3, wherein among the plurality of electronic components, one or more electronic components disposed in a first region facing the plate portion are greater in a maximum height from the circuit substrate than one or more electronic components disposed in a second region facing the convex portion.

5. The display device according to claim 4, wherein the convex portion of the light guide plate includes a back end surface portion coupling the side surface portion and the slope portion and arranged to face the circuit substrate with a predetermined gap between the back end surface portion and the circuit substrate.

6. The display device according to claim 1, wherein the light guide plate includes a light guide pattern that transitions from coarse to dense in a direction away from the light emitting body.

7. The display device according to claim 1, further comprising a light-transmitting plate provided on a front side of the light guide plate and having light transmissivity.

8. The display device according to claim 4, wherein the LCD includes a panel on an outer periphery portion and is provided with a visible region closer to a center side than the panel.

9. The display device according to claim 8, wherein the slope portion of the convex portion of the light guide plate is arranged to face a region outside the visible region.

10. The display device according to claim 5, wherein the back end surface portion of the light guide plate is arranged closer to the circuit board than a light source of the light emitting body.

11. A watch comprising:
the display device according to claim 1;
a watch case; and
a watch module provided inside the watch case.

12. A watch comprising:
the display device according to claim 2;
a watch case; and
a watch module provided inside the watch case.
